(19) United States
(12) Patent Application Publication
(10) Pub. No.: US 2025/0200935 A1
(43) Pub. Date: Jun. 19, 2025

(54) SERVER AND NON-TRANSITORY COMPUTER-READABLE STORAGE MEDIUM

(71) Applicant: Panasonic Intellectual Property Management Co., Ltd., Osaka (JP)

(72) Inventor: Daijiroh ICHIMURA, Hyogo (JP)

(73) Assignee: Panasonic Intellectual Property Management Co., Ltd., Osaka (JP)

(21) Appl. No.: 19/065,134

(22) Filed: Feb. 27, 2025

Related U.S. Application Data
(63) Continuation of application No. PCT/JP2023/016634, filed on Apr. 27, 2023.

(30) Foreign Application Priority Data
Sep. 27, 2022 (JP) 2022-153981

(51) Int. Cl. G06V 10/74; G06T 7/73

(52) U.S. Cl. CPC G06V 10/761; G06T 7/75; G06T 2207/10024; G06T 2207/10028

(57) ABSTRACT

A server according to an aspect of the present disclosure is used in an identity determination system. The identity determination system includes a sender terminal and a recipient terminal. The server includes a processor configured to: receive, from the sender terminal, first feature information indicating a first object to be sent by a sender to a recipient; receive, from the recipient terminal, second feature information indicating a second object received by the recipient; perform matching processing that matches the first feature information with the second feature information; and determine whether the first object corresponds to the second object based on a result of the matching processing.

### CROSS REFERENCE TO RELATED APPLICATION

This application claims priority to Japanese Patent Application 2022-153981, filed on Sep. 27, 2022, the contents of which are incorporated herein by reference.

### BACKGROUND

### Technical Field

The present disclosure relates to a server and a non-transitory computer-readable storage medium.

### Background Art

Services for transferring objects between individuals have become widespread. JP 2021-121979 A discloses a technology such as a control program of a computer that can make simpler a registration operation of a commodity sold by a user at the time of using such services and that provides the user with an appropriate price for the commodity sold by the user.

### SUMMARY

In order to deliver and receive an object between a sender and a recipient of the object with a sense of security, it is desirable to provide a technique that matches an object sent by the sender with an object received by the recipient and confirms whether both are the same. However, JP 2021-121979 A does not disclose such a technique.

An object of the present disclosure provides a server and a non-transitory computer-readable storage medium capable of more accurately determining the identity between an object sent by a sender and an object received by a recipient.

A server according to an aspect of the present disclosure is used in an identity determination system. The identity determination system includes a sender terminal and a recipient terminal. The server includes a processor configured to:
receive, from the sender terminal, first feature information indicating a first object to be sent by a sender to a recipient;
receive, from the recipient terminal, second feature information indicating a second object received by the recipient;
perform matching processing that matches the first feature information with the second feature information; and
determine whether the first object corresponds to the second object based on a result of the matching processing.

A non-transitory computer-readable storage medium according an aspect of the present disclosure stores a program executed by a processor of a server used in an identity determination system. The identity determination system includes a sender terminal and a recipient terminal. The program causes the processor to execute processing comprising:
receiving, from a sender terminal of the sender, first feature information indicating a first object to be sent by a sender to a recipient;
receiving, from a recipient terminal of the recipient, second feature information indicating a second object received by the recipient;
matching the first feature information with the second feature information; and
determining whether the first object corresponds to the second object based on a result of the matching.

With the server and the non-transitory computer-readable storage medium according to the present disclosure, it is possible to more accurately determine identity between an object sent by a sender and an object received by a recipient.

### BRIEF DESCRIPTION OF DRAWINGS

FIG. 1 is a schematic diagram illustrating an example of identity determination performed in an identity determination system according to a first embodiment of the present disclosure;

FIG. 2 is a block diagram illustrating a configuration example of a server according to the first embodiment;

FIG. 3 is a block diagram illustrating a configuration example of a sender terminal according to the first embodiment;

FIG. 4 is a block diagram illustrating a configuration example of a recipient terminal according to the first embodiment;

FIG. 5 is a sequence diagram illustrating an example of a flow of processing in the identity determination system of FIG. 1;

FIG. 6 is a flowchart illustrating an example of a flow of identity determination processing performed by the server according to the first embodiment;

FIG. 7 is a flowchart for describing an operation of the recipient terminal according to the first embodiment;

FIG. 8 is a schematic diagram illustrating a display example of a recording required portion;

FIG. 9 is a flowchart illustrating an example of a flow of identity determination processing performed by the server according to a second embodiment;

FIG. 10 is a flowchart illustrating an example of a flow of the identity determination processing performed by the server according to the second embodiment;

FIG. 11 is a flowchart for describing an operation of a sender terminal according to the second embodiment;

FIG. 12 is a flowchart illustrating an example of a flow of identity determination processing performed by a server according to a third embodiment;

FIG. 13 is a flowchart illustrating an example of a flow of the identity determination processing performed by the server according to the third embodiment;

FIG. 14 is a flowchart for describing an operation of a sender terminal according to the third embodiment;

FIG. 15 is a block diagram illustrating a configuration example of an identity determination system according to a fourth embodiment; and

FIG. 16 is a sequence diagram illustrating an example of a flow of processing in the identity determination system of FIG. 15.

### DETAILED DESCRIPTION

In the following, embodiments will be described in detail with reference to the drawings as appropriate. However, unnecessarily detailed description may be omitted. For example, a detailed description of already well-known matters and repeated description of substantially the same configuration may be omitted. This is to prevent the following description from being unnecessarily redundant and to allow a person skilled in the art to easily understand the present disclosure.

Note that the applicant provides the accompanying drawings and the following description in order for a person skilled in the art to fully understand the present disclosure, and does not intend to limit subject matters recited in the claims.

### 1. First Embodiment

### 1-1. Overview

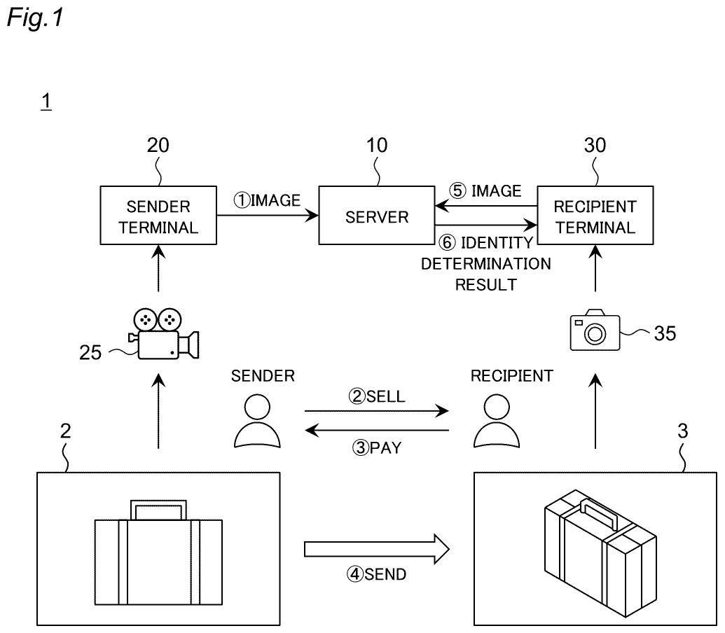

FIG. 1 is a schematic diagram illustrating an example of identity determination performed by an identity determination system 1 according to a first embodiment of the present disclosure. Here, description will be given on an example of identity determination in the following case example. Commodity trade is performed using, for example, an electronic commerce service, and a sender (addresser or consignor) as a seller sends the commodity to a recipient (consignee) as a buyer. The electronic commerce service is a service that provides convenience for a user to perform a transaction of commodity, and includes, for example, an auction service, a shopping service, a flea market service.

An example of commodity trade using an electronic commerce service and identity determination according to the present embodiment is as follows. Note that terms “sender (seller)” and “recipient (buyer)” are used on the premise that a sales contract is established. Note that before the sales contract is established, persons corresponding to the sender and the recipient are still, for example, an exhibitor (vendor) and a would-be buyer, respectively.

First, the sender obtains a sending object image 2 by imaging a commodity with a camera 25. The sender transmits the sending object image 2 to a server 10, using a sender terminal 20.

Next, in the electronic commerce service, the sender, who is the seller, sells the commodity (sending object) to a recipient, who is the buyer. The recipient pays the sender a price of the commodity.

Next, the sender sends the commodity to the recipient. For example, the sender requests a transporter such as a courier to deliver the sending object (or the object to be sent) to the recipient. The recipient receives the object (receiving object) from the transporter.

The above case example is an example of a typical flow of commodity trade using an electronic commerce service. In such a case example, the sending object (or the sent object) and the receiving object (or received object) should normally be the same. However, there can be a case where the receiving object is not an object that the recipient intends to receive. For example, the following situation may occur. A genuine product should be bought, but a receiving object is not a genuine product, or a sending object sent by the sender and a receiving object received by the recipient are different objects. Therefore, the recipient may feel uneasy about whether the receiving object can be the same as an object that the recipient intends to buy. In order to solve such a problem, the inventor has accomplished a technique in which a sending object sent by a sender is matched with a receiving object received by a recipient and it is thereby determined whether both are the same.

In order to perform the identity determination, the identity determination system 1 according to the present embodiment performs the following processing. The recipient transmits, to the server 10, a receiving object image 3 obtained by imaging the receiving object (second object) received from the transporter with a camera 35. The server 10 matches a feature (or feature amount) of the sending object image 2 (hereinafter, the feature may be referred to as “first feature”) with a feature of the receiving object image 3 (hereinafter, the feature may be referred to as “second feature”) to determine whether the sending object and the receiving object are the same, and transmits an identity determination result to a recipient terminal 30. The first feature is an example of “first feature information” of the present disclosure, and the second feature is an example of “second feature information” of the present disclosure. For example, the feature information may be physical feature information of the object. Specifically, the feature information may be three-dimensional feature information, or may be information regarding a shape, an area, a temperature, and the like of the object. The feature information may be information related to a sound, a logo, a character, a stain, a scratch, or the like related to an object.

The recipient can know the identity determination result by checking a display screen of the recipient terminal 30. Therefore, the recipient can use the electronic commerce service with a sense of security as compared with before.

Hereinafter, details of the present embodiment will be described.

### 1-2. Configuration

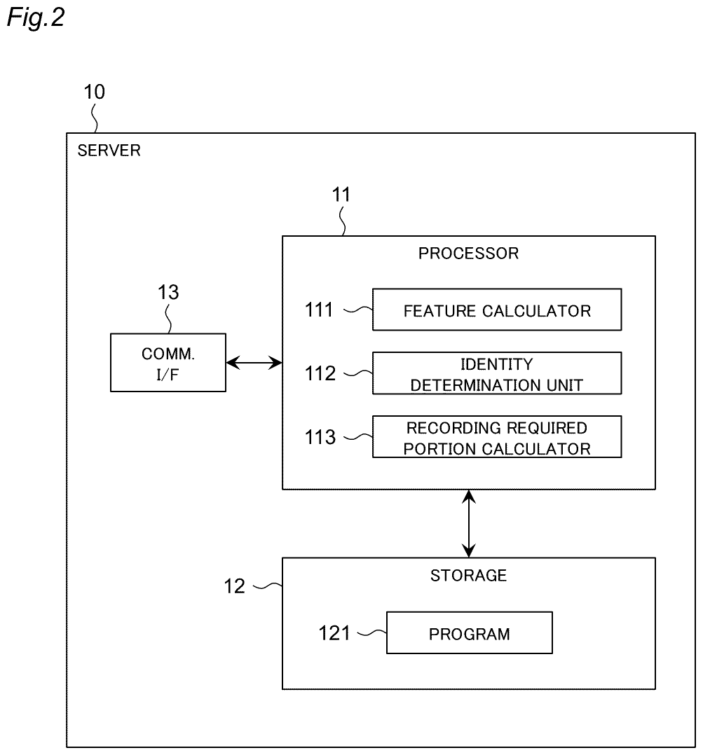

FIG. 2 is a block diagram illustrating a configuration example of the server 10 according to the present embodiment. The server 10 includes a processor 11, a storage 12, and a communication interface (I/F) 13.

The processor 11 performs information processing to realize a function of the server 10. Such information processing is realized, for example, by the processor 11 operating in accordance with a command of a program 121 stored in the storage 12. The processor 11 is configured with, for example, a circuit such as a central processing unit (CPU), a microprocessor unit (MPU), or a field programmable gate array (FPGA). The processor 11 may be realized by such a circuit alone, or may be realized by a plurality of circuits. Furthermore, regarding components of the processor 11, a function may be appropriately omitted, replaced, and added, depending on the embodiment.

By operating in accordance with a command of a program, the processor 11 functions as a feature calculator 111, an identity determination unit 112, or a recording required portion calculator 113. In FIG. 2, the above functions are provided as blocks for convenience of understanding.

The storage 12 stores various types of data including the program 121 necessary for realizing the function of the server 10. The storage 12 is realized by, for example, a semiconductor storage such as a flash memory or a solid state drive (SSD), a magnetic storage such as a hard disk drive (HDD), or another recording medium alone or in combination thereof. The storage 12 may include a transitory storage such as static random access memory (SRAM) or dynamic random access memory (DRAM).

A communication interface 13 is an interface circuit that performs data communication in accordance with an existing wired communication standard or a wireless communication standard. The processor 11 can perform data communication with the sender terminal 20 and the recipient terminal 30 via the communication interface 13 and the network.

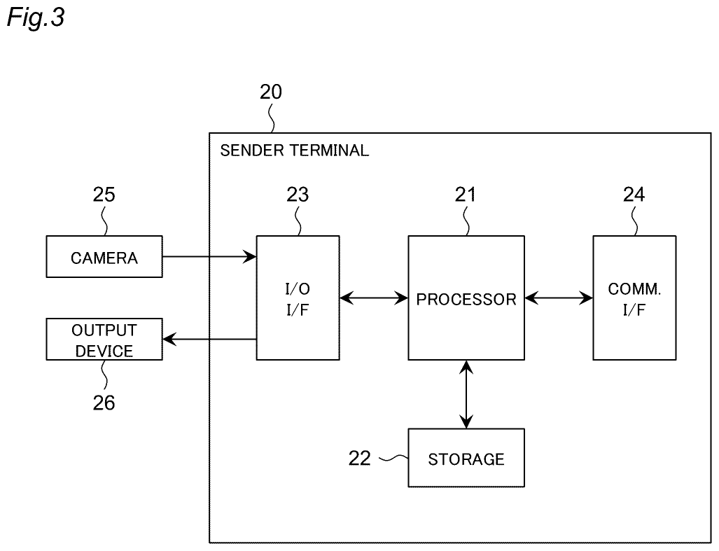

FIG. 3 is a block diagram illustrating a configuration example of the sender terminal 20 according to the present embodiment. The sender terminal 20 includes a processor 21, a storage 22, an input/output interface 23, and a communication interface 24.

The processor 21 performs information processing to realize a function of the sender terminal 20. Such information processing is realized, for example, by the processor 21 operating in accordance with a command of a program stored in the storage 22. The processor 21 is configured with, for example, a circuit such as a central processing unit (CPU), a microprocessor unit (MPU), or a field programmable gate array (FPGA). The processor 21 may be realized by such a circuit alone, or may be realized by a plurality of circuits. Furthermore, regarding components of the processor 21, a function may be appropriately omitted, replaced, and added, depending on the embodiment.

The storage 22 stores various types of data including a program necessary for realizing the function of the sender terminal 20. The storage 22 may have a configuration similar to that of the storage 12.

The input/output interface 23 is an interface circuit that connects the sender terminal 20 and an external device in order to receive information from the external device such as the camera 25 and an output device 26 or to output information to the external device. The input/output interface 23 may be a communication circuit that performs data communication in accordance with an existing wired communication standard or a wireless communication standard.

The communication interface 24 is a communication circuit that performs data communication in accordance with an existing wired communication standard and/or a wireless communication standard.

The camera 25 is an imaging device that captures an image of a surrounding environment to generate captured image data. The camera 25 generates captured image data by, for example, a solid-state imaging element such as a complementary metal-oxide semiconductor (CMOS) or a charged coupled device (CCD). The captured image data generated by the camera 25 is input to the sender terminal 20 via the input/output interface 23. Note that, in the present specification, image data may be simply expressed as “image”.

The output device 26 is a device that outputs information, and includes, for example, a display device such as a liquid crystal display or an organic EL display or an audio output device such as a speaker.

FIG. 3 illustrates an example in which the camera 25 and the output device 26 are external devices of the sender terminal 20, but the present embodiment is not limited to such a configuration. For example, the sender terminal 20 and at least one of the camera 25 or the output device 26 may be accommodated in one casing to be integrally configured. The terminal integrally configured as described above includes, for example, a smartphone, a tablet device, a laptop, and the like.

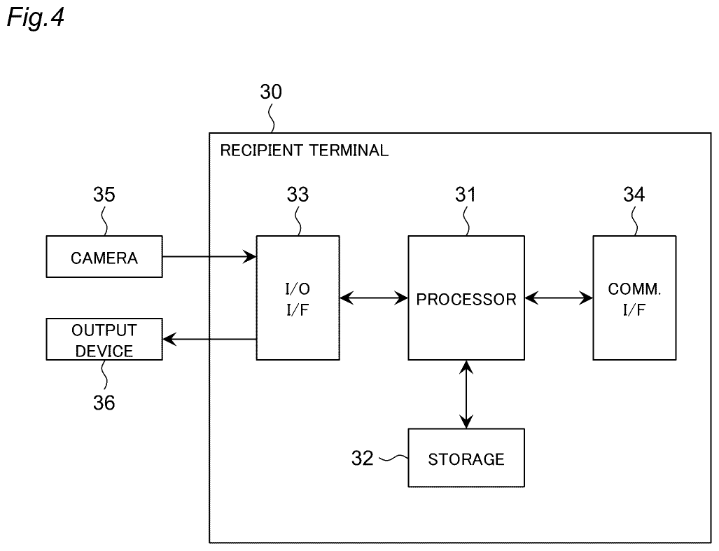

FIG. 4 is a block diagram illustrating a configuration example of the recipient terminal 30 according to the present embodiment. The recipient terminal 30 includes a processor 31, a storage 32, an input/output interface 33, and a communication interface 34.

The processor 31 performs information processing to realize a function of the recipient terminal 30. Such information processing is realized, for example, by the processor 31 operating in accordance with a command of a program stored in the storage 32. The processor 31 is configured with, for example, a circuit such as a CPU, an MPU, or an FPGA. The processor 31 may be realized by such a circuit alone, or may be realized by a plurality of circuits. Furthermore, regarding components of the processor 31, a function may be appropriately omitted, replaced, and added, depending on the embodiment.

The storage 32 stores various types of data including a program necessary for realizing the function of the recipient terminal 30. The storage 32 may have a configuration similar to that of the storage 12 or 22.

The input/output interface 33 is an interface circuit that connects the recipient terminal 30 and an external device in order to receive information from the external device such as the camera 35 and an output device 36 or to output information to the external device. The input/output interface 33 may be a communication circuit that performs data communication in accordance with an existing wired communication standard or a wireless communication standard.

The communication interface 34 is a communication circuit that performs data communication in accordance with an existing wired communication standard and/or a wireless communication standard.

The camera 35 is an imaging device that captures an image of a surrounding environment to generate captured image data. The camera 35 generates captured image data by, for example, a solid-state imaging element such as a CMOS or a CCD.

The output device 36 is a device that outputs information, and includes, for example, a display device such as a liquid crystal display or an organic EL display or an audio output device such as a speaker.

FIG. 4 illustrates an example in which the camera 35 and the output device 36 are external devices of the recipient terminal 30, but the present embodiment is not limited to such a configuration. For example, the recipient terminal 30 and at least one of the camera 35 or the output device 36 may be accommodated in one casing to be integrally configured. Such an integrated configuration includes, for example, a smartphone, a tablet device, a laptop, and the like.

### 1-3. Operation

### 1-3-1. Overall System Operation

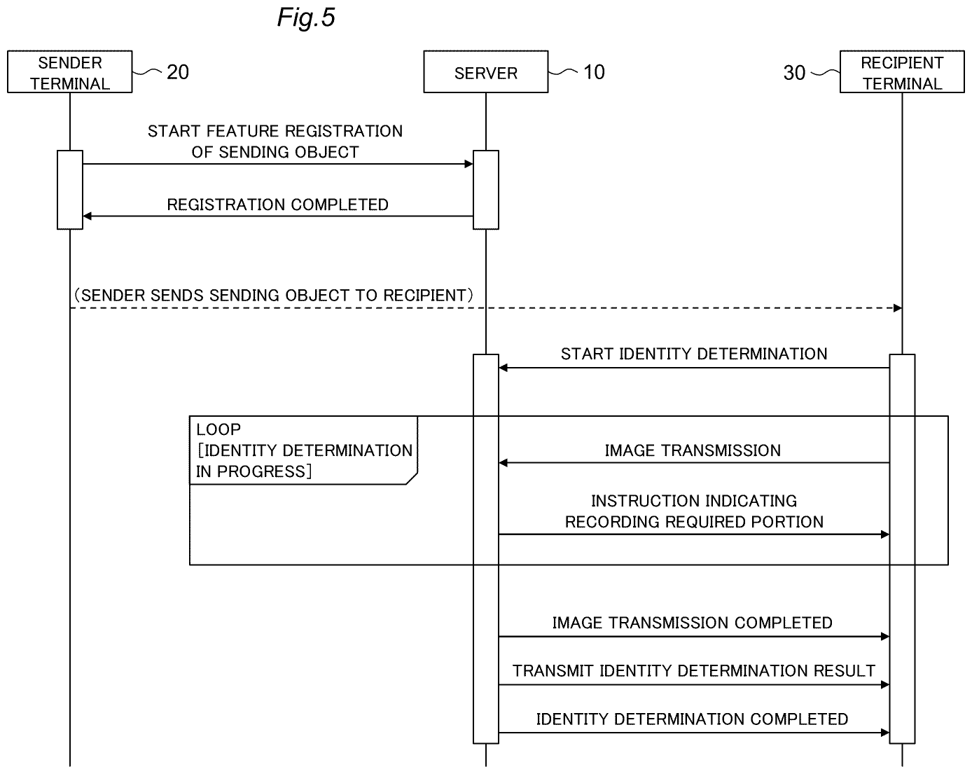

FIG. 5 is a sequence diagram illustrating an example of a flow of processing in the identity determination system 1 of FIG. 1.

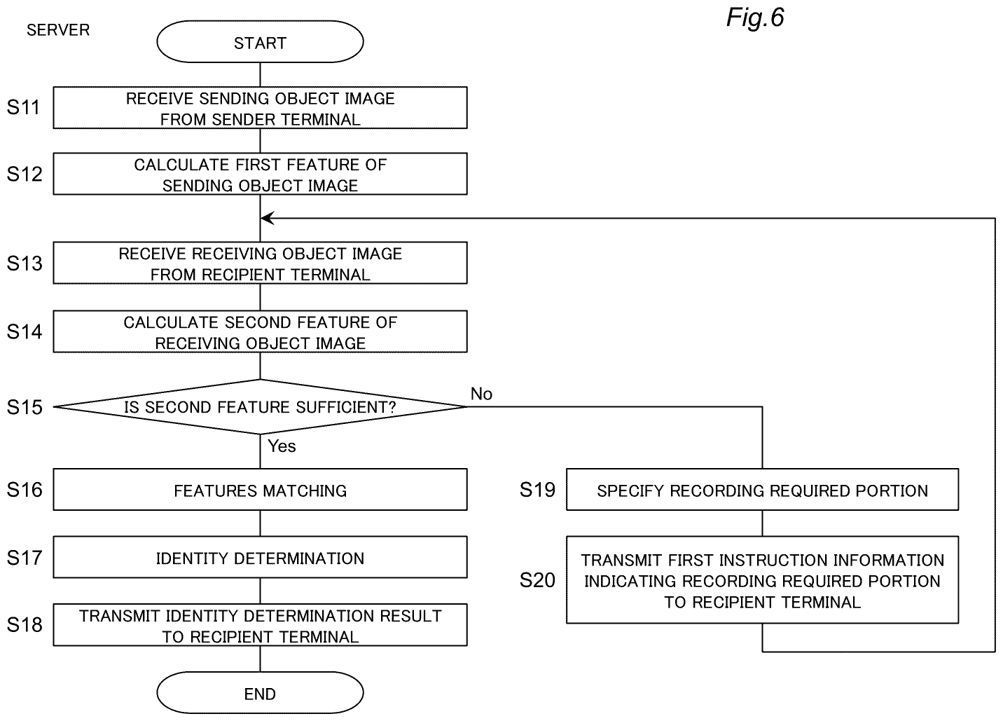

As illustrated in FIG. 5, first, the sender terminal 20 and the server 10 perform registration processing of the feature of the sending object. For example, the sender terminal 20 transmits the sending object image 2 to the server 10, and the server 10 calculates and stores the feature of the sending object image 2 (see step S12 in FIG. 6).

As indicated by the arrowed broken line in FIG. 5, after the registration processing of the feature of the sending object, the sender typically sends the sending object to the recipient.

Next, the server 10 starts identity determination processing. The identity determination processing is started, triggered by the recipient terminal 30 transmitting the receiving object image 3 to the server 10. When the feature of the receiving object image 3 is sufficiently present for matching with the feature of the sending object image 2, the server 10 performs matching processing (see step S16 in FIG. 6) to perform identity determination (see step S17 in FIG. 6). Thereafter, the server 10 transmits an identity determination result to the recipient terminal 30.

On the other hand, in a case where the feature of the receiving object image 3 does not sufficiently exist in the identity determination processing, the server 10 transmits to the recipient terminal 30 first instruction information indicating a part (recording required portion) of the receiving object necessary for the identity determination processing. This is processing intended to request the recipient to capture an image of the recording required portion with the camera 35. The recipient captures an image of the recording required portion with the camera 35, and transmits the image of the recording required portion to the server 10. The transmission of the first instruction information and the transmission of the image of the recording required portion are repeated as necessary.

Hereinafter, a description will be given in more detail on an operation each of the server 10, the sender terminal 20, and the recipient terminal 30.

### 1-3-2. Operation of Server Device 10

FIG. 6 is a flowchart illustrating an example of a flow of the identity determination processing by the server 10 according to the present embodiment. The processing of FIG. 6 is performed by the processor 11 of the server 10. For example, steps S11 to S14 in FIG. 6 are performed by the feature calculator 111 of the processor 11, steps S15 to S18 are performed by the identity determination unit 112, and steps S19 and S20 are performed by the recording required portion calculator 113.

In FIG. 6, first, the processor 11 receives the sending object image 2 from the sender terminal 20 (S11). The sending object image 2 is an image or image data that the sender has obtained by capturing, with the camera 25, an image of the sending object (first object) sent to the recipient. In the present specification, the image may be a still image or a moving image. The image may be a multi-viewpoint image obtained by imaging the sending object from a plurality of different directions.

Next, the processor 11 calculates the feature (first feature) of the sending object image 2 (S12). The calculated first feature is stored in, for example, the storage 12.

The first feature may be a feature of the image. The feature of the image is obtained by analyzing the image. An example of the feature is a local binary pattern (LBP) feature, a speeded-up robust features (SURF) feature, a scale-invariant feature transform (SIFT) feature, a histograms of oriented gradients (HOG) feature, or a Haar-like feature. The feature may be represented by a vector, for example, and be referred to as a feature vector.

The feature of the image may be a feature obtained by inputting an image to a trained model trained by machine learning. The trained model receives an image as an input and outputs a feature as an output. Such a trained model is obtained, for example, by causing a model having a structure of a convolutional neural network (CNN) to learn a large number of images.

Next, the processor 11 receives the receiving object image 3 from the recipient terminal 30 (S13). The receiving object image 3 is an image or image data that the recipient has obtained by capturing, with the camera 35, an image of the receiving object (second object) received from a transporter such as a courier.

Next, the processor 11 calculates the feature (second feature) of the receiving object image 3 received in step S13 (S14). The calculated second feature is stored in, for example, the storage 12.

Next, the processor 11 determines whether the second feature is sufficient (S15). That the second feature is sufficient means that, for example, the second feature exists to such an extent that the second feature can be matched with the first feature.

When the second feature is sufficient (Yes in S15), the processor 11 performs matching processing to match the first feature with the second feature (S16). For example, the matching processing may include calculating a distance such as a Euclidean distance between the first feature and the second feature.

On the basis of a result of the matching processing S16, the processor 11 determines whether the sending object sent by the sender is the same as the receiving object received by the recipient (S17). For example, in a case where a similarity indicating an index of a degree of similarity between the first feature and the second feature is a predetermined threshold value or more, the processor 11 determines that the sending object and the receiving object are the same. Such similarity is determined, for example, on the basis of the distance between the first feature and the second feature calculated in step S16. For example, the similarity is larger as the distance between the first feature and the second feature is smaller.

Next, the processor 11 transmits a result of the identity determination processing S17 to the recipient terminal 30 via the communication interface 13 (S18).

When, in step S15, the second feature is not sufficient (No in S15), the processor 11 specifies a recording required portion regarding the receiving object (S19). Feature information (third feature information) obtained by recording the recording required portion specified in step S19 is at least one piece of information associated with the receiving object. The third feature information includes information that, when added to the second feature, enables matching of the first feature with the second feature after being added with the recording required portion. For example, the recording required portion is a portion regarding which the second feature does not include sufficient feature data for matching with the first feature. In other words, in a case where the second feature is not sufficient, the feature of the second feature to which the feature of the recording required portion is added can be matched with the first feature.

For example, in step S19, when the second feature is less than the first feature, the processor 11 specifies, as the recording required portion, a part of the receiving object image 3 that corresponds to the difference between the first feature and the second feature. When the second feature is smaller than a reference feature previously stored in the storage 12, the processor 11 may specify, as the recording required portion, a part of the receiving object image 3 that corresponds to the difference between the reference feature and the second feature.

In an example where the sending object image 2 and the receiving object image 3 are matched as in the present embodiment, in a case where, while the sending object image 2 or the first feature includes a portion that has a character, a stain, or a scratch, the receiving object image 3 or the second feature does not includes a part corresponding to such a portion, the processor 11 may specify such a portion as the recording required portion.

In a case where the number of the recording required portions is two or more, the processor 11 may determine a priority order of each of the recording required portions on the basis of the difference between the first feature and the second feature or the difference between the reference feature and the second feature. For example, a priority order of the recording required portion indicating a logo, character, a stain, or a scratch of the receiving object is set higher than priority orders of the recording required portion indicating the other parts of the receiving object.

After step S19, the processor 11 transmits, to the recipient terminal 30, the first instruction information indicating the recording required portion (S20). The first instruction information is information for obtaining feature information or a feature, regarding the second feature, capable of being matched with the first feature. For example, the processor 11 may transmit, to the recipient terminal, data itself indicating the recording required portion. Alternatively, when the recording required portion can be specified as a portion corresponding to a position such as a front surface, a back surface, a side surface, a corner, or an edge of the receiving object shown in the receiving object image 3, the processor 11 may transmit first instruction information indicating such a portion to the recipient terminal.

When step S20 is completed, the processor 11 performs step S13 again.

In the case of No in step S15, there may be a limitation in the number of times of loop processing returning to step S13 via steps S19 and S20. For example, in a case where the number of times of the case of No in step S15 reaches a predetermined value, the processor 11 ends the process of FIG. 6. As a result, it possible to avoid an infinite loop from being performed in the process of FIG. 6.

Note that, unlike the example illustrated in FIG. 6, steps S15 and S16 may be integrally executed. For example, when the first feature and the second feature cannot be matched in step S16, step S19 may be performed. As described above, the case where the second feature is not sufficient (No in S15) is an example of the case where the first feature and the second feature cannot be matched in the matching processing.

### 1-3-3. Operation of Recipient Terminal 30

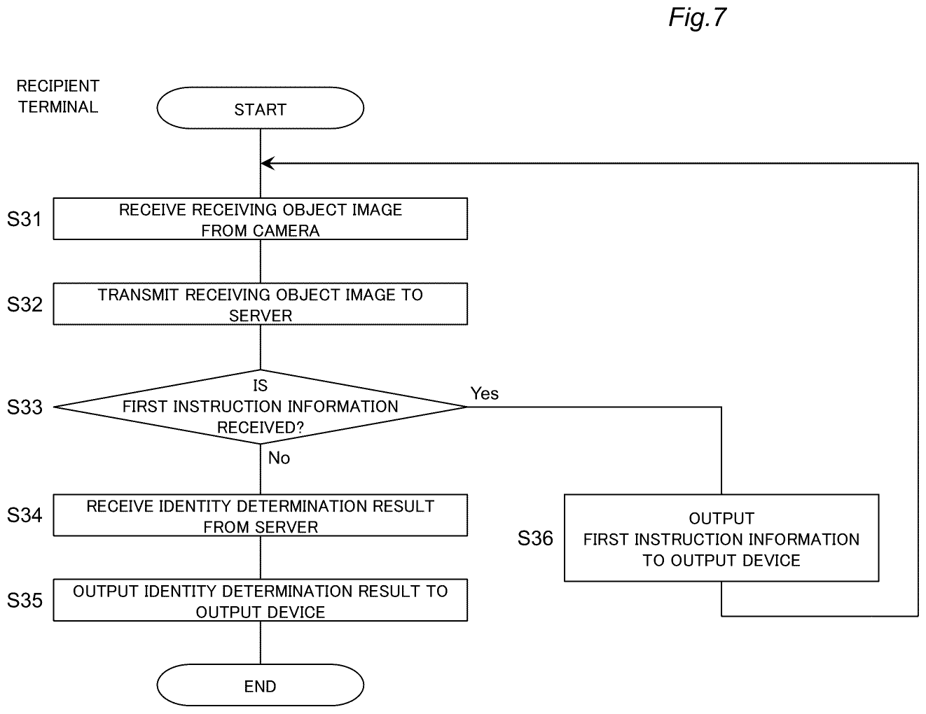

FIG. 7 is a flowchart for describing an operation of the recipient terminal 30. The process of FIG. 7 is performed by the processor 31 of the recipient terminal 30.

First, the processor 31 acquires a receiving object image 3 from the camera 35 (S31), and transmits the acquired receiving object image 3 to the server 10 (S32). The thus transmitted receiving object image 3 is received by the server 10 in step S13 in FIG. 6.

Next, the processor 31 determines whether the first instruction information is received from the server 10 (S33). The first instruction information is transmitted from the server 10 in step S20 in FIG. 6.

A case where the first instruction information is not received in step S33 (No in S33) corresponds to the case where the second feature is sufficient in step S15 in FIG. 6 (Yes in S15). Therefore, in this case, the result of the identity determination processing S17 is transmitted from the server 10 to the recipient terminal 30. The processor 31 of the recipient terminal 30 receives the result of the identity determination processing S17 transmitted from the server 10 (S34).

Next, the processor 31 outputs the result of the identity determination processing S17 received in step S34 to the output device 36 (S35).

When the first instruction information is received in step S33 (Yes in S33), the processor 31 outputs the first instruction information to the output device 36 (S36). For example, the processor 31 outputs, as the first instruction information, data itself indicating a recording required portion to the output device 36.

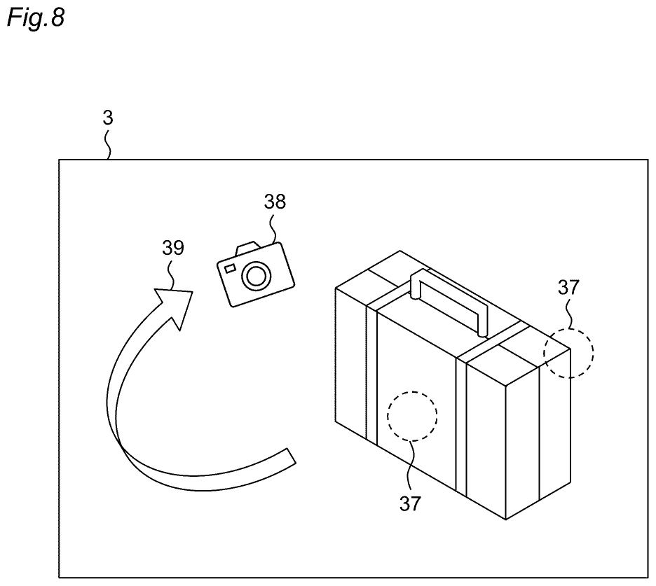

Alternatively, in step S36, when the recording required portion can be specified as a portion corresponding to a position of a front surface, a back surface, a side surface, a corner, an edge, or the like of the receiving object shown in the receiving object image 3, the processor 31 may output the first instruction information indicating such a portion to the output device 36. For example, the output device 36 outputs a text or a voice message “Please take a picture of the front face” on the basis of the first instruction information. Furthermore, for example, the output device 36 may display the recording required portion in a superimposing manner on the receiving object image 3 on the basis of the first instruction information. As FIG. 8 illustrates an example, in a case where the recording required portion is displayed, the output device 36 may display, as the recording required portion, the following item in a superimposing manner on the receiving object image 3: a heat map 37 in accordance with a degree of insufficiency of the feature; an imaging position display 38 or an arrow 39 that indicates a direction from which an image should be taken; or the like.

When step S36 is completed, the processor 31 performs step S31 again. In the case of No in step S33, there may be a limitation in the number of times of loop processing returning to step S31 via step S36.

### 1-4. Conclusion

As described above, the processor 11 of the server 10 receives, from the sender terminal 20 of the sender, the first feature indicating the sending object sent by the sender to the recipient (S11). The processor 11 receives, from the recipient terminal 30 of the recipient, the second feature indicating the receiving object received by the recipient (S13). The processor 11 performs the matching processing that matches the first feature with the second feature (S16). The processor 11 determines whether the sending object corresponds to the receiving object based on the result of the matching processing (S17). This configuration enables the server 10 to more accurately determine the identity between the sending object and the receiving object.

When the first feature and the second feature cannot be matched in the matching processing, the processor 11 may further perform transmission processing of transmitting, to the recipient terminal, the first instruction information for obtaining at least one third feature regarding the second object. The at least one third feature regarding the second object is information that, when added to the second feature, enables matching between the first feature and the second feature to which the at least one third feature is added. As a result, the server 10 can obtain the second feature to which the at least one third feature is added, and can more accurately determine the identity between the first feature and the second feature to which the at least one third feature is added.

When the number of the third features instructed from the server 10 is two or more, the processor 11 may determine the priority order of each of the third features on the basis of the difference between the first feature and the second feature. In this case, the processor transmits, in the transmission processing, the first instruction information to the recipient terminal on the basis of the determined priority order. With this configuration, the identity between the sending object and the receiving object can be determined more accurately.

### 2. Second Embodiment

### 2-1. Overview

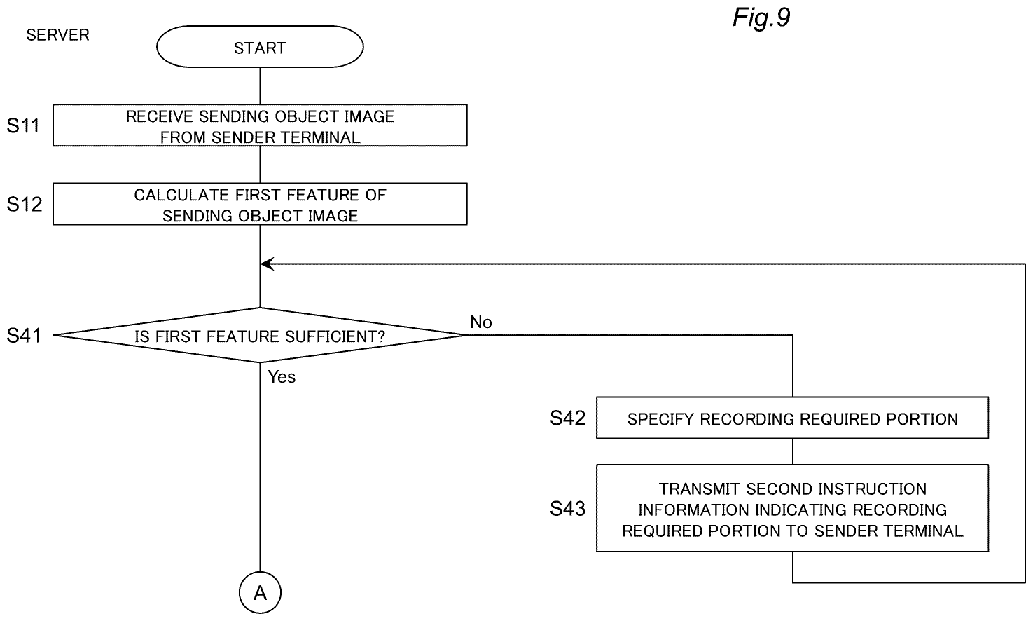

An operation of an identity determination system 1 according to a second embodiment of the present disclosure will be described with reference to FIGS. 9 to 11. The identity determination system 1 according to the second embodiment has a configuration similar to that of the identity determination system 1 according to the first embodiment.

In the first embodiment, an example has been described in which only the recipient terminal 30 can receive, from the server 10, the first instruction information indicating the recording required portion. Unlike the first embodiment, in the second embodiment, the sender terminal 20 can also receive instruction information (second instruction information) indicating a recording required portion from the server 10. Since the sender follows the second instruction information and provides the recording required portion to the server 10, the server 10 can improve the accuracy of the identity determination.

### 2-2. Operation of Server Device 10

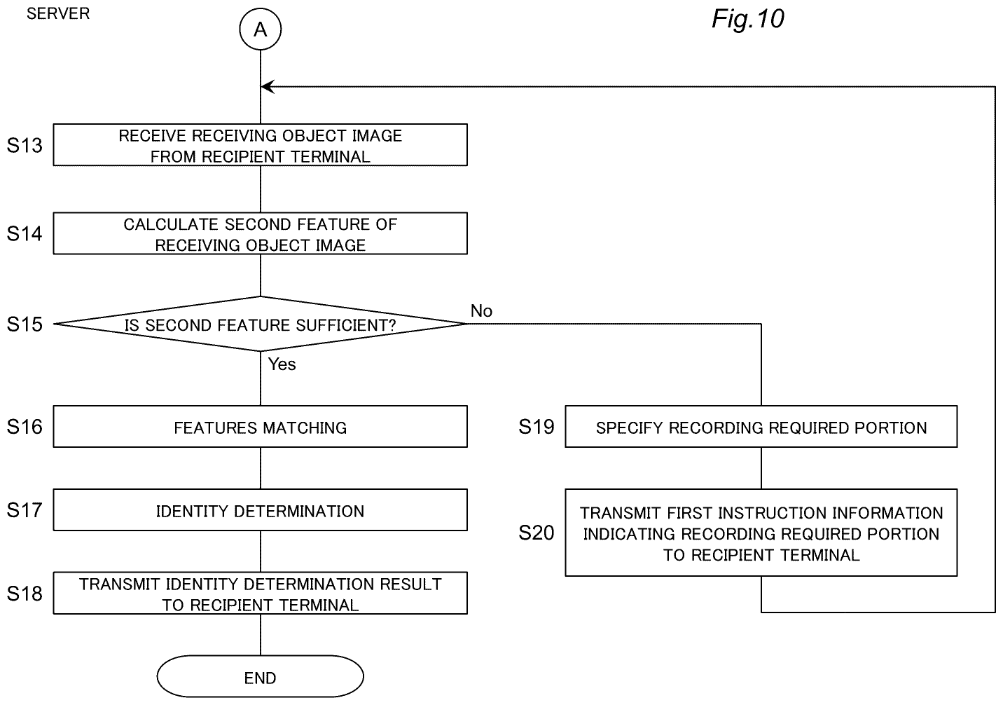

FIGS. 9 and 10 are flowcharts each illustrating an example of a flow of identity determination processing by the server 10 according to the present embodiment. First, similarly to the first embodiment, the processor 11 receives a sending object image 2 from the sender terminal 20 (S11), and calculates a first feature of the sending object image 2 (S12).

Next, the processor 11 determines whether the first feature is sufficient (S41). That the first feature is sufficient means that, for example, the first feature exists to such an extent that the first feature satisfies a predetermined condition.

An example of a case where the predetermined condition is not satisfied is as follows. For example, in a case where the first feature is less than a reference feature previously stored in the storage 12, the processor 11 determines that the predetermined condition is not satisfied. Furthermore, when an image quality of the sending object image 2 is poor, the processor 11 may determine that the predetermined condition is not satisfied. Examples of the case where the image quality of the sending object image 2 is poor include the following cases: a case where the sending object is out of focus in the sending object image 2; a case where a resolution of the sending object image 2 is less than a predetermined resolution; and a case where lightness or brightness of the sending object image 2 is greater than a predetermined upper limit value or less than a predetermined lower limit value. Alternatively, when, although a feature such as a character, a stain, or a scratch is detected in the sending object image 2, such a feature is not in focus, the processor 11 may determine that the predetermined condition is not satisfied.

When the first feature is sufficient (Yes in S41), the flowchart in FIG. 9 continues to step S13 in FIG. 10 via the connector A. Steps S13 to S19 in FIG. 10 are similar to steps S13 to S19 in FIG. 6, and description of FIG. 10 is therefore omitted.

When, in step S41, the first feature is not sufficient (No in S41), the processor 11 specifies a recording required portion regarding the sending object (S42). The recording required portion specified in step S42 is information necessary for the first feature to satisfy a predetermined condition.

After step S42, the processor 11 transmits, to the sender terminal 20, the second instruction information indicating the recording required portion (S43). The second instruction information is information for obtaining feature information or a feature necessary for the first feature to satisfy a predetermined condition.

When step S43 is completed, the processor 11 performs step S41 again. In the case of No in step S41, there may be a limitation in the number of times of loop processing returning to step S41 via steps S42 and S43.

### 2-3. Operation of Sender Terminal 20

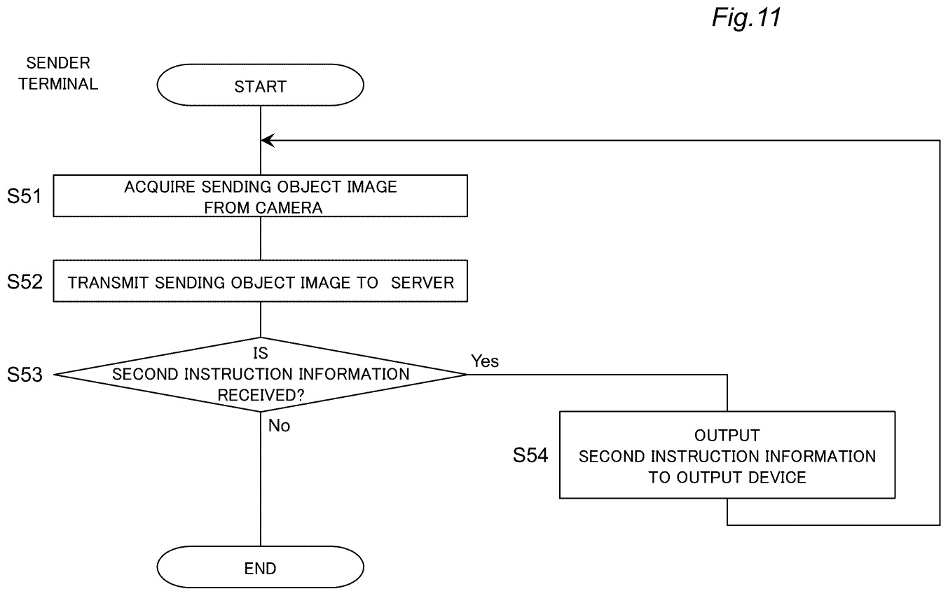

FIG. 11 is a flowchart for describing an operation of the sender terminal 20 according to the present embodiment. The process of FIG. 11 is performed by the processor 21 of the sender terminal 20.

First, the processor 21 acquires the sending object image 2 from the camera 25 (S51), and transmits the acquired sending object image 2 to the server 10 (S52). The thus transmitted sending object image 2 is received by the server 10 in step S11 in FIG. 9.

Next, the processor 21 determines whether the second instruction information is received from the server 10 (S53). The second instruction information is transmitted from the server 10 in step S43 in FIG. 9.

When the second instruction information is not received in step S53 (No in S53), the processor 21 ends the process of FIG. 11. This case corresponds to a case where the first feature is sufficient in step S41 of FIG. 9 (Yes in S41). Therefore, in this case, the server 10 performs the processing in and after step S13 in FIG. 10.

When the second instruction information is received in step S53 (Yes in S53), the processor 21 outputs the second instruction information to the output device 26 (S54). For example, the processor 21 outputs, as the second instruction information, data itself indicating a recording required portion to the output device 26.

Alternatively, in step S54, the processor 21 may output, as the second instruction information, a message indicating a recording required portion to the output device 26. For example, when the sending object image 2 is an image in which the sending object is out of focus, the output device 26 outputs a text or a voice message “Please take a picture in focus” or “Please take a picture again” on the basis of the second instruction information. Furthermore, for example, when a character is detected in the sending object image 2, the output device 26 outputs a text or a voice message “Please take an image of a character on the commodity” on the basis of the second instruction information. When lightness or brightness of the sending object image 2 is larger than a predetermined upper limit value, the output device 26 may output a text or a voice message such as “Please lower the luminance”.

In addition to such information, the output device 26 may output a text or a voice message indicating a position of the character on the sending object. Furthermore, when outputting such a position, the output device 26 may display, as the recording required portion, information such as a pointer, a heat map, or the like indicating the position, in a superimposing manner on the sending object image 2.

When step S54 is completed, the processor 21 perform step S51 again. In the case of No in step S53, there may be a limitation in the number of times of loop processing returning to step S51 via step S54.

### 2-4. Conclusion

As described above, in the server 10 according to the present embodiment, when the first feature received from the sender terminal 20 does not satisfy a predetermined condition, the processor 11 transmits, to the sender terminal 20, the second instruction information necessary for the first feature to satisfy the predetermined condition.

With this configuration, the sender can capture an image of the recording required portion with the camera 25 in accordance with the second instruction information obtained by the sender terminal 20, and can provide the server 10 with the image of the recording required portion via the sender terminal 20. As a result, the server 10 can obtain a sufficient sending object image 2 when determining the identity, and can improve the accuracy of the matching between the sending object image 2 and the receiving object image 3 and improve the accuracy of the identity determination.

### 3. Third Embodiment

### 3-1. Overview

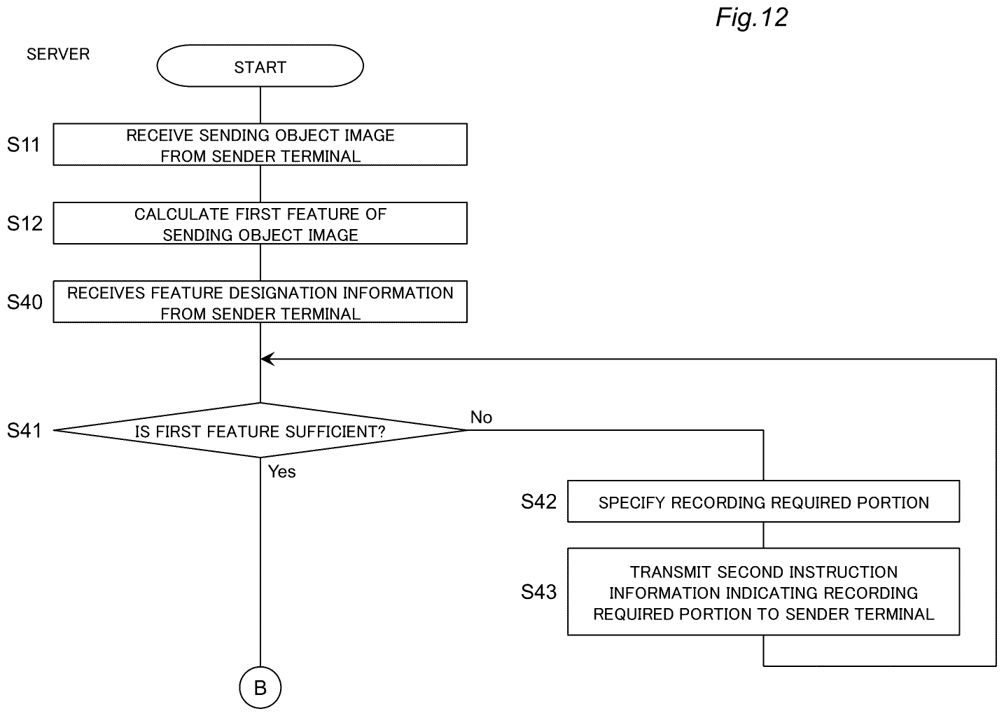

An operation of an identity determination system 1 according to a third embodiment of the present disclosure will be described with reference to FIGS. 12 to 14. The identity determination system 1 according to the third embodiment has a configuration similar to that of the identity determination system 1 according to the first and second embodiments.

In the third embodiment, the sender designates, as feature designation information, a part of the sending object on which the sender puts emphasis and the like, and registers the feature designation information in the server 10. For example, in a case where the sending object is an art object such as a curving, the sender designates, as the feature designation information, a part where a various techniques are used, the sender's signature, or the like.

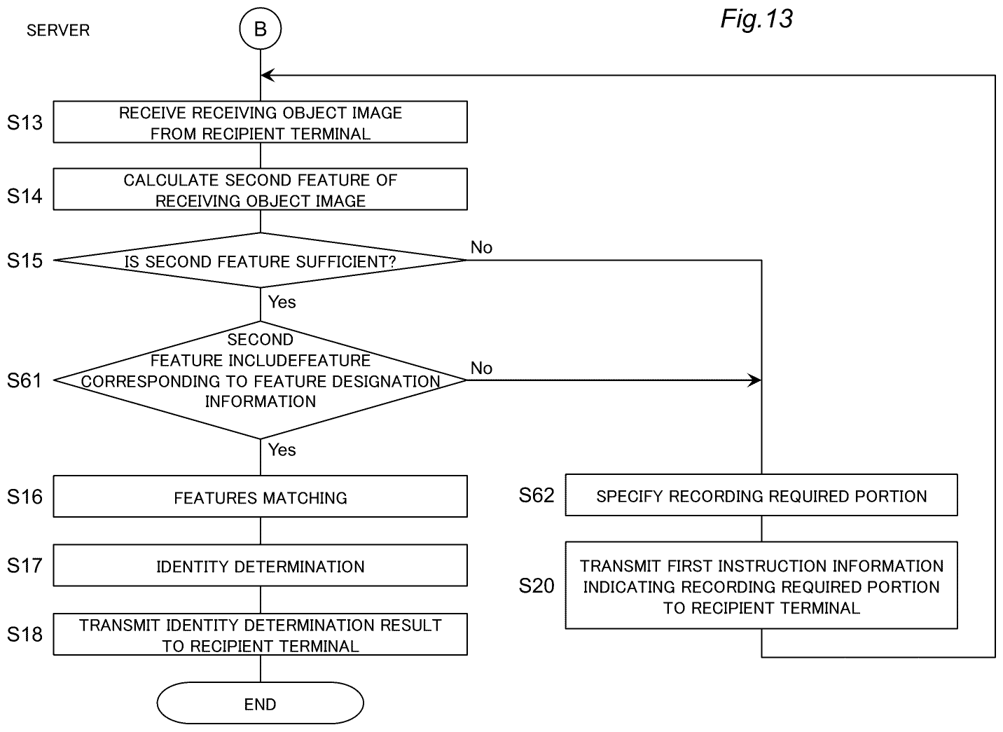

In order to realize this operation, as compared with the operation of the server 10 according to the second embodiment illustrated in FIGS. 9 and 10, the server 10 according to the third embodiment further performs steps S40 and S61 (see FIGS. 12 and 13), and performs step S62 instead of step S19 in FIG. 10.

### 3-2. Operation of Server Device 10

FIGS. 12 and 13 are flowcharts each illustrating an example of a flow of identity determination processing by the server 10 according to the present embodiment. First, similarly to the first and second embodiments, the processor 11 receives the sending object image 2 from the sender terminal 20 (S11), and calculates a first feature of the sending object image 2 (S12).

Furthermore, the processor 11 receives the feature designation information from the sender terminal 20 (S40). Step S40 may be performed before step S11 or between step S11 and step S12, which is a different order from the order illustrated in FIG. 12.

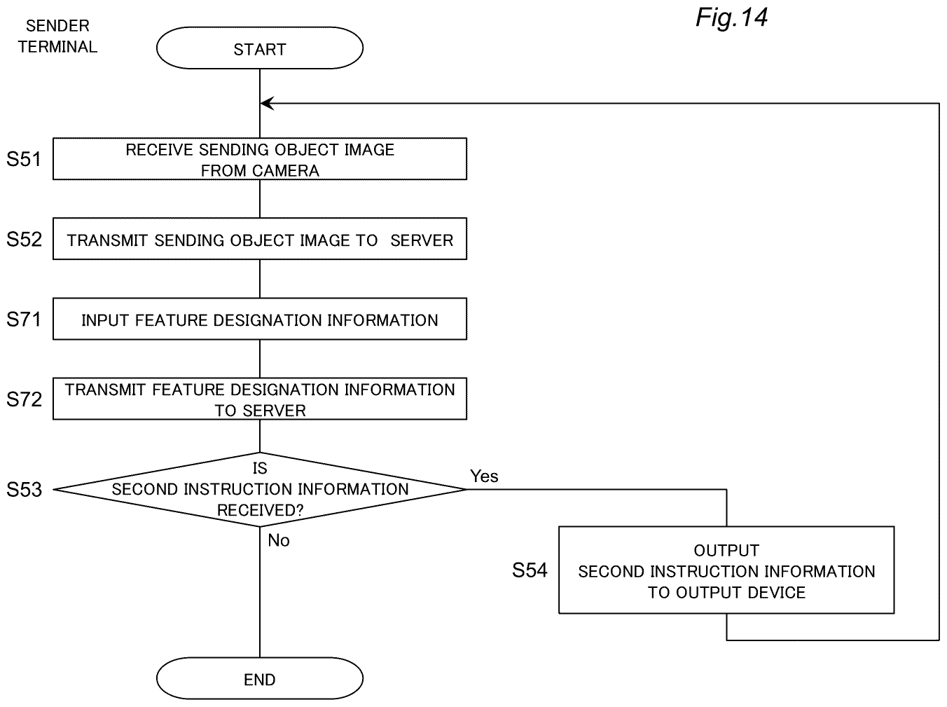

The feature designation information is an example of additional feature information that is associated with the sending object and is designated by the sender. The sender inputs the feature designation information to the sender terminal 20, using input devices such as a keyboard, a mouse, a touch panel, and an input unit of the camera 25 (see S71 in FIG. 14 described later).

For example, the sender designates, as the feature designation information, a part of the sending object on which the sender puts stress, a part that the sender feels is characteristic, an important part, and the like. Alternatively, the sender may input classification information of the sending object to the sender terminal 20, and the processor 21 may determine the feature designation information on the basis of the input classification information. In the present specification, the above described determination of the feature designation information by the processor 21 is also included in the input of the feature designation information to the sender terminal 20.

Steps S41, S42, and S43 following step S40 in FIG. 12 are similar to those in FIG. 9, and description will be omitted.

When the first feature is sufficient in step S41 (Yes in S41), the flowchart of FIG. 12 continues to step S13 in FIG. 13 via the connector B.

In steps S13 and S14 in FIG. 13, as described above, the processor 11 receives the receiving object image 3 from the recipient terminal 30 and calculates the second feature.

When the second feature is sufficient (Yes in S15), the processor 11 determines whether the second feature includes the feature corresponding to the feature designation information received in step S40 in FIG. 12 (hereinafter, the feature may be referred to as “fourth feature information” or “fourth feature”) (S61).

For example, in the following case, the processor 11 determines that the second feature does not include the fourth feature (No in S61). In a case where, although the sender has designated, as the feature designation information, a part of the sending object where a various techniques are used, a part where the sender has signed the sender's signature, or the like, the fourth feature indicating such parts is not detected on the receiving object image 3 captured by the recipient.

When the second feature includes the fourth feature corresponding to the feature designation information (Yes in S61), the processor 11 performs steps S16 to S18. Since steps S16 to S18 are similar to those in FIG. 10, description will be omitted.

In a case where the second feature is not sufficient in step S15 (No in S15), or in a case where the second feature does not include the fourth feature corresponding to the feature designation information in step S61, the processor 11 performs step S62. In step S62, the processor 11 specifies a recording required portion regarding the receiving object.

The recording required portion specified in step S62 includes a portion indicating the fourth feature corresponding to the feature designation information in addition to the recording required portion specified in step S19 of FIG. 6. In an example where the sending object image 2 and the receiving object image 3 are matched as in the present embodiment, in a case where, while the sending object image 2 includes a portion that has a character, a stain, or a scratch as the feature designation information, the receiving object image 3 does not include a part corresponding to such a portion, the processor 11 may specify such a portion as the recording required portion.

In a case where the number of the recording required portions is two or more, the processor 11 may determine the priority order of each recording required portion on the basis of the feature designation information. For example, the priority order of the recording required portion corresponding to the feature designation information is set higher than the priority order of the recording required portion indicating the other parts of the receiving object.

Next to step S62, the processor 11 transmits the second instruction information indicating a recording required portion to the recipient terminal 30 (No in S20), and then performs step S13 again.

In the example illustrated in FIG. 13, step S15 and step S61 have been described as separate processes, but in another example, step S15 may include step S61. For example, when the second feature does not include the fourth feature corresponding to the feature designation information (this case corresponds to the case of No in S61 in FIG. 13), the processor 11 determines in step S15 that the second feature is not sufficient (No in S15). That is, in the another example, that the second feature including the fourth feature corresponding to the feature designation information is an example of the fact that the second feature is sufficient (Yes in S15).

### 3-3. Operation of Sender Terminal 20

FIG. 14 is a flowchart for describing an operation of a sender terminal 20 according to the present embodiment. As compared with the flowchart of FIG. 11 according to the second embodiment, the flowchart of FIG. 14 further includes steps S71 and S72 in addition to steps S51 to S54 included also in FIG. 11.

In step S71, the processor 21 receives the feature designation information input by the sender. The feature designation information is input from an input device such as a keyboard, a mouse, a touch panel, or an input unit of the camera 25 to the processor 21 via the input/output interface 23.

After step S71, the processor 21 transmits the input feature designation information to the server 10 (No in S72).

Steps S71 and S72 may be performed before step S51 or between step S51 and step S52, which is a different order from the order illustrated in FIG. 14.

### 3-4. Conclusion

As described above, in the process in step S11 or S12, the processor 11 of the server 10 according to the present embodiment further receives, from the sender terminal 20, additional feature information that is associated with the sending object and is designated by the sender. In the process in step S11 or S12, the sending object image 2 or the first feature, which is an example of the first feature information, is received from the sender terminal 20. When the receiving object image or the second feature, which is an example of the second feature information, received in step S13 or S14 does not include the fourth feature corresponding to the additional feature information, the processor 11 transmits to the recipient terminal 30 the second instruction information for obtaining the fourth feature.

With this configuration, the recipient can acquire with the camera 35 the fourth feature corresponding to the additional feature information in accordance with the second instruction information that the recipient has become to know via the recipient terminal 30, and can provide the fourth feature to the server 10 via the recipient terminal 30. As a result, the server 10 can obtain the feature including the fourth feature regarding the receiving object, and can improve the accuracy of the matching and the identity determination between the sending object image 2 and the receiving object image 3.

### 4. Fourth Embodiment

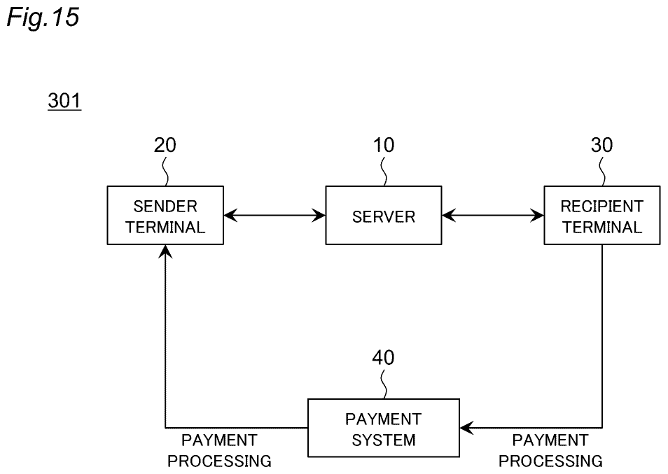

FIG. 15 is a block diagram illustrating a configuration example of an identity determination system 301 according to a fourth embodiment. The identity determination system 301 is used in a sales contract in which a sender is a seller and a recipient is a buyer. As compared with the identity determination system 1 according to the first embodiment illustrated in FIG. 1, the identity determination system 301 further includes a payment system 40.

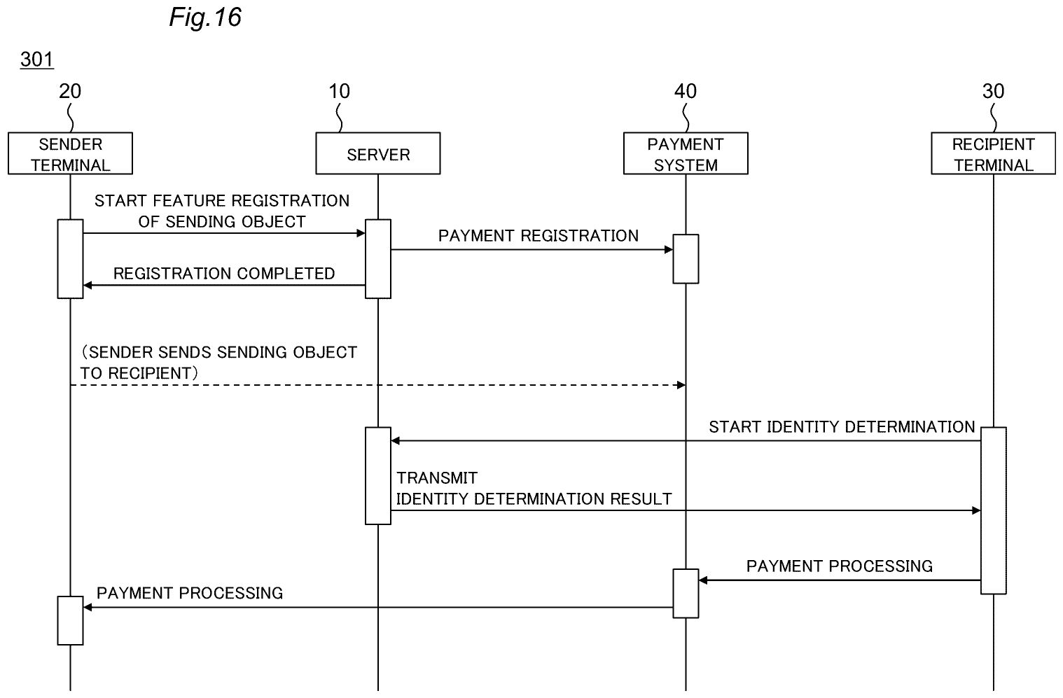

FIG. 16 is a sequence diagram illustrating an example of a flow of processing in the identity determination system 301 of FIG. 15. As illustrated in FIG. 16, first, the sender terminal 20 and the server 10 perform registration processing of the feature of the sending object. For example, the sender terminal 20 transmits the sending object image 2 to the server 10, and the server 10 calculates and stores the feature of the sending object image 2.

The server 10 performs payment registration on the payment system 40. In the payment registration, the server 10 transmits information necessary for payment to the payment system 40. The information necessary for payment includes, for example, commodity information, a transaction ID, key information for making payment, or an account number of the sender.

As indicated by the arrowed broken line in FIG. 16, after the registration processing of the feature of the sending object, the sender normally sends the sending object to the recipient. The sending object may be sent after the payment registration or before the payment registration.

Next, the server 10 starts the identity determination processing. The server 10 transmits the identity determination result to the recipient terminal 30. The recipient can know the identity determination result by checking the display screen of the recipient terminal 30.

After confirming the identity determination result that the sending object and the receiving object are the same, the recipient performs payment processing on the payment system 40 using the recipient terminal 30. As a result, the recipient pays a selling price to the sender.

In contrast, when the recipient obtains the identity determination result indicating that the sending object and the receiving object are not the same, it can be thought that the recipient does not perform the payment processing. Alternatively, in the case where the processor 11 of the server 10 determines that the sending object and the receiving object are not the same, the processor may transmit, to the sender terminal 20, a message saying that a payment of the selling price is refused. As a result, it is possible to prevent the recipient from paying the selling price to the sender when the receiving object is not the intended object, and the recipient therefore can use the electronic commerce service with a sense of security.

### 5. Other Embodiments

In the above, the preferred embodiments have been described as examples of the techniques in the present disclosure. For that purpose, the accompanying drawings and the detailed description are provided. The components illustrated in the accompanying drawings and described in the detailed description not only include components essential for solving the problem but also can include, to exemplify the techniques, components that are not essential for solving the problem. For this reason, it should not be recognized that those unnecessary components are necessary only because those unnecessary components are described in the accompanying drawings or the detailed description.

Since the embodiments described above are for exemplifying the techniques in the present disclosure, various modifications, replacements, additions, omissions, and the like can be made in the scope of the claims or in an equivalent scope thereof. Hereinafter, modifications will be described as other such embodiments.

### 5-1. First Modification

In the first embodiment, an example has been described in which the processor 11 of the server 10 receives the sending object image 2 in step S11 of FIG. 6 and calculates the first feature of the sending object image 2 in step S12. However, the method by which the processor 11 acquires the first feature is not limited to this example. For example, the first feature may be calculated in the sender terminal 20, and the processor 11 of the server 10 may receive the first feature from the sender terminal 20.

Similarly, in the first embodiment, an example has been described in which the processor 11 receives the receiving object image 3 in step S13 in FIG. 6 and calculates the second feature of the receiving object image 3 in step S14, but the method by which the processor 11 acquires the second feature is not limited to this example. For example, the second feature may be calculated in the recipient terminal 30, and the processor 11 of the server 10 may receive the second feature from the recipient terminal 30.

### 5-2. Second Modification

In the first to fourth embodiments and the first modification, the examples have been described in which the feature information is a feature of an image. That is, in the first embodiment and the first modification, the examples have been described in which the first feature information is the first feature and the second feature information is the second feature. However, the first and second feature information are not limited to these pieces of information.

For example, the feature information may be an image or image data. The first feature information may be the sending object image 2, and the second feature information may be the receiving object image 3. The feature information may be a combination of an image or image data and a feature thereof. The image may be an RGB image or a distance image (depth image) using information acquired from a distance sensor or the like. The image data may include a camera internal parameter indicating a camera focus or other information when each image is captured. The image data may include information such as camera external parameter including camera position data indicating a camera position or other information when an image is captured.

### 5-3. Third Modification

The feature information may be a 3D model of the object. The 3D model may include data such as point cloud data or mesh data. For example, the first feature information may be a 3D model of the sending object and the second feature information may be a 3D model of the receiving object. In one example, a process of generating a 3D model from a multi-viewpoint image is performed in the processor 21 of the sender terminal 20 or the processor 31 of the recipient terminal 30, and the server 10 acquires the 3D model from the sender terminal 20 or the recipient terminal 30. Alternatively, the processor 11 of the server 10 may acquire a multi-viewpoint image from the sender terminal 20 or the recipient terminal 30, and generate a 3D model on the basis of the acquired multi-viewpoint image.

A method for generating a 3D model from a multi-viewpoint image is disclosed in, for example, Japanese Patent No. 4491293, Jacob Munkberg et al., Extracting Triangular 3D Models, Materials, and Lighting From Images, arXiv: 2111.12503, and the like.

In the case of the present modification, the recording required portion (third feature information) regarding the receiving object specified in step S19 in FIG. 6 may be a part where the 3D model is not formed or a part where the 3D model is missing with respect to the receiving object. In this case, in step S36 in FIG. 7, the processor 31 may display, on the basis of the first instruction information, a 3D model or an image indicating the recording required portion in a superimposing manner on an image of the receiving object displayed on a display, which is an example of the output device 36.

Furthermore, in step S34 in FIG. 7, in which the recipient terminal 30 receives the result of the identity determination processing, the recipient terminal 30 may further receive the 3D models of the sending object and the receiving object. As a result, the recipient can compare the 3D models of the sending object and the receiving object, using the display or the like of the recipient terminal 30. The recipient can view each of the 3D models of the receiving object and the sending object, from various angles. Furthermore, the recipient can accurately check unevenness, a size, and the like of the entire or a notable part by using the 3D models. Therefore, the recipient may verify in more detail whether the sending object and the receiving object are the same.

In a case where the present modification is applied to the second embodiment, in step S41 in FIG. 9, the processor 11 may determine that the first feature is not sufficient (No in S41) when there is a part where the 3D model is not formed regarding the sending object or there is a part where the 3D model is missing regarding the sending object.

### 5-4. Fourth Modification

The feature information may be audio information. For example, the first feature information may be a sound generated from the sending object, and the second feature information may be a sound generated from the receiving object. In a case where the sending object or the receiving object is an audio output device such as a speaker, such audio information is, for example, a sound that the sending object or the receiving object outputs by being supplied with electric power. Alternatively, the audio information may be a sound that the sending object itself or the receiving object itself generates. Examples of the sound generated from the object itself include a sound generated by the object when the object is a musical instrument or a sound generated by hitting the object. The feature information may be voice data itself or a feature obtained by analyzing the voice data.

In a case where the present modification is applied to the first embodiment, in step S36 of FIG. 7, the processor 31 may cause the output device 36 to output a text or a voice message such as “Please play the audio file”, “Please play the musical instrument”, “Please hit”, or the like, on the basis of the first instruction information.

### 5-5. Fifth Modification

The feature information may be temperature information. For example, the first feature information may be a temperature of the sending object and the second feature information may be a temperature of the receiving object. Such temperature information is the temperature of the sending object or the receiving object under a specific condition, and is measured by, for example, a temperature sensor. For example, the first feature information and the second feature information are respectively temperatures of the sending object and the receiving object when an environmental temperature is a predetermined temperature. Alternatively, in a case where the sending object and the receiving object are a heat source such as a heater, the first feature information and the second feature information may be respectively temperatures of the sending object and the receiving object at a time point when a predetermined time has elapsed after activation.

In a case where the present modification is applied to the first embodiment, in step S36 of FIG. 7, the processor 31 may cause the output device 36 to output a text or a voice message such as “Please bring the temperature sensor close” on the basis of the first instruction information.

### 5-6. Sixth Modification

In the third embodiment, an example has been described in which, in a case where the sending object is an art object, the sender designates, as the feature designation information, a part where a various techniques are used, the sender's signature, or the like, but the example of the feature designation information is not limited thereto. For example, the sender may designate, as the feature designation information, characters such as a serial number written on or engraved in the sending object.

### 6. Example of Aspects

Hereinafter, various aspects according to the present disclosure will be listed.

### <Aspect 1>

A server used in an identity determination system, wherein the identity determination system includes a sender terminal and a recipient terminal, the server comprising a processor configured to:
receive, from the sender terminal, first feature information indicating a first object to be sent by a sender to a recipient;
receive, from the recipient terminal, second feature information indicating a second object received by the recipient;
perform matching processing that matches the first feature information with the second feature information; and
determine whether the first object corresponds to the second object based on a result of the matching processing.

### <Aspect 2>

The server according to claim 1, wherein when the first feature information and the second feature information are not matched in the matching processing, the processor further performs transmission processing that transmits, to the recipient terminal, first instruction information for obtaining at least one piece of third feature information associated with the second object, the at least one piece of third information being configured to match the first feature information with the second feature information by being added to the second feature information.

### <Aspect 3>

The server according to claim 2, wherein the processor is configured to:
determine, when a number of pieces of the third feature information is two or more, a priority order for each piece of the third feature information based on a difference between the first feature information and the second feature information, and
transmit the first instruction information to the recipient terminal based on the determined priority order in the transmission processing.

### <Aspect 4>

The server according to claim 1, wherein when the first feature information received by the processor from the sender terminal does not satisfy a predetermined condition, the processor transmits, to the sender terminal, information necessary for the first feature information to satisfy the predetermined condition.

### <Aspect 5>

The server according to claim 1, wherein the processor is configured to:
further receive from the sender terminal, in processing of receiving the first feature information from the sender terminal, additional feature information that is associated with the first object and is designated by the sender; and
transmit to the recipient terminal, when the second feature information received in processing of receiving the second feature information from the recipient terminal does not include fourth feature information corresponding to the additional feature information, second instruction information for obtaining the fourth feature information.

### <Aspect 6>

The server according to claim 1, wherein the server is used in a sales contract in which the sender is a seller and the recipient is a buyer, and
when the processor determines that the first object does not correspond to the second object, the processor transmits a message indicating that a payment of a selling price is refused to the sender terminal.

### <Aspect 7>

The server according to claim 1, wherein the first feature information includes image data of the first object, and the second feature information includes image data of the second object.

### <Aspect 8>

The server according to claim 7, wherein the image data includes at least one of RGB image data, distance image data, or camera position data.

### <Aspect 9>

The server according to claim 1, wherein the first feature information includes a 3D model of the first object, and the second feature information includes a 3D model of the second object.

### <Aspect 10>

The server according to claim 9, wherein the 3D models include at least one of point cloud data or mesh data.

### <Aspect 11>

The server according to claim 1, wherein the first feature information includes information indicating a sound generated from the first object, and the second feature information includes information indicating a sound generated from the second object.

### <Aspect 12>

The server according to claim 1, wherein the first feature information includes information indicating a temperature of the first object, and the second feature information includes information indicating a temperature of the second object.

### <Aspect 13>

A non-transitory computer-readable storage medium storing a program executed by a processor of a server used in an identity determination system, wherein the identity determination system includes a sender terminal and a recipient terminal, the program causing the processor to execute processing comprising:
receiving, from a sender terminal of the sender, first feature information indicating a first object to be sent by a sender to a recipient;
receiving, from a recipient terminal of the recipient, second feature information indicating a second object received by the recipient;
matching the first feature information with the second feature information; and
determining whether the first object corresponds to the second object based on a result of the matching.

### <Aspect 14>

A method performed by a processor of a server used in an identity determination system, wherein the identity determination system includes a sender terminal and a recipient terminal, the method comprising:
receiving, by the processor from a sender terminal of the sender, first feature information indicating a first object to be sent by a sender to a recipient;
receiving, by the processor from a recipient terminal of the recipient, second feature information indicating a second object received by the recipient;
matching, by the processor, the first feature information with the second feature information; and
determining, by the processor, whether the first object corresponds to the second object based on a result of the matching.

The present disclosure is applicable to servers that communicate with an external terminal such as a sender terminal and a recipient terminal.

What is claimed is:

1. A server used in an identity determination system, wherein the identity determination system includes a sender terminal and a recipient terminal, the server comprising a processor configured to:
receive, from the sender terminal, first feature information indicating a first object to be sent by a sender to a recipient;
receive, from the recipient terminal, second feature information indicating a second object received by the recipient;
perform matching processing that matches the first feature information with the second feature information; and
determine whether the first object corresponds to the second object based on a result of the matching processing.

2. The server according to claim 1, wherein when the first feature information and the second feature information are not matched in the matching processing, the processor further performs transmission processing that transmits, to the recipient terminal, first instruction information for obtaining at least one piece of third feature information associated with the second object, the at least one piece of third information being configured to match the first feature information with the second feature information by being added to the second feature information.

3. The server according to claim 2, wherein the processor is configured to:
determine, when a number of pieces of the third feature information is two or more, a priority order for each piece of the third feature information based on a difference between the first feature information and the second feature information, and
transmit the first instruction information to the recipient terminal based on the determined priority order in the transmission processing.

4. The server according to claim 1, wherein when the first feature information received by the processor from the sender terminal does not satisfy a predetermined condition, the processor transmits, to the sender terminal, information necessary for the first feature information to satisfy the predetermined condition.

5. The server according to claim 1, wherein the processor is configured to:
further receive from the sender terminal, in processing of receiving the first feature information from the sender terminal, additional feature information that is associated with the first object and is designated by the sender; and
transmit to the recipient terminal, when the second feature information received in processing of receiving the second feature information from the recipient terminal does not include fourth feature information corresponding to the additional feature information, second instruction information for obtaining the fourth feature information.

6. The server according to claim 1, wherein the server is used in a sales contract in which the sender is a seller and the recipient is a buyer, and
when the processor determines that the first object does not correspond to the second object, the processor transmits a message indicating that a payment of a selling price is refused to the sender terminal.

7. The server according to claim 1, wherein the first feature information includes image data of the first object, and the second feature information includes image data of the second object.

8. The server according to claim 7, wherein the image data includes at least one of RGB image data, distance image data, or camera position data.

9. The server according to claim 1, wherein the first feature information includes a 3D model of the first object, and the second feature information includes a 3D model of the second object.

10. The server according to claim 9, wherein the 3D models include at least one of point cloud data or mesh data.

11. The server according to claim 1, wherein the first feature information includes information indicating a sound generated from the first object, and the second feature information includes information indicating a sound generated from the second object.

12. The server according to claim 1, wherein the first feature information includes information indicating a temperature of the first object, and the second feature information includes information indicating a temperature of the second object.

13. A non-transitory computer-readable storage medium storing a program executed by a processor of a server used in an identity determination system, wherein the identity determination system includes a sender terminal and a recipient terminal, the program causing the processor to execute processing comprising:
receiving, from a sender terminal of the sender, first feature information indicating a first object to be sent by a sender to a recipient;
receiving, from a recipient terminal of the recipient, second feature information indicating a second object received by the recipient;
matching the first feature information with the second feature information; and
determining whether the first object corresponds to the second object based on a result of the matching.
